(19) United States
(12) Patent Application Publication
(10) Pub. No.: US 2016/0368629 A1
(43) Pub. Date: Dec. 22, 2016

(54) SYSTEMS AND METHODS FOR ALIQUOTING FLUIDS

(71) Applicant: Stratos Group LLC, Seattle, WA (US)

(72) Inventor: Adam Storey, Seattle, WA (US)

(21) Appl. No.: 15/160,791

(22) Filed: May 20, 2016

Related U.S. Application Data
(60) Provisional application No. 62/164,453, filed on May 20, 2015.
(60) Provisional application No. 62/305,986, filed on Mar. 9, 2016.

(51) Int. Cl. B65B 3/04; B01F 7/00; B65B 7/16; B01F 5/10; B65B 3/00; B65B 3/28

(52) U.S. Cl. CPC B65B 3/04; B65B 3/003; B65B 3/28; B65B 7/161; B01F 5/108; B01F 7/0025; B01F 2215/0032

(57) ABSTRACT

Systems and methods for aliquoting fluids such as mammalian cells suspended in a cryoprotectant solution are provided. The systems and methods generally facilitate the aseptic transfer of fluid from an input container (e.g., flexible solution container) to a plurality of output containers (e.g., cryogenic vials) via a manifold (e.g., single-use manifold including tubing). The systems may include a control system, a pump, control valves and one or more sensors for aseptically routing the fluid from the input container to the output containers in an at least partially automated manner. System components may further include an agitation mechanism to ensure substantial homogenization of the fluid prior to and during transfer, and one or more temperature control devices to maintain the fluid within a desired temperature range.

### BACKGROUND

### Technical Field

The present disclosure relates generally to systems and methods for aliquoting therapeutic products and, more specifically, to systems and methods for aliquoting therapeutic products such as cancer cell therapy products prior to cryopreservation.

### BRIEF SUMMARY

The systems and methods generally facilitate the aseptic transfer of therapeutic fluid from an input container (e.g., flexible solution container) to a plurality of output containers (e.g., cryogenic vials) via a manifold (e.g., single-use manifold including tubing and valving). The systems may include a control system, a pump, control valves and one or more sensors for aseptically routing the therapeutic fluid from the input container to the output containers in an at least partially automated manner. System components may further include an agitation mechanism to ensure substantial homogenization of the therapeutic fluid prior to and during transfer and one or more temperature control devices to maintain the therapeutic fluid being transferred within a desired temperature range.

### BRIEF DESCRIPTION OF THE SEVERAL VIEWS OF THE DRAWINGS

FIG. 1 shows perspective views for two possible architectures of a system for aseptically transferring therapeutic fluid from an input container into a plurality of output containers, according to one example embodiment.

FIG. 2 is a perspective view of a single-use manifold including tubing and valving, according to one example embodiment, with a plurality of output containers in the form of cryogenic vials coupled thereto.

FIG. 3 is a perspective view of an alternative single-use manifold including tubing and valving, according to one example embodiment, with a plurality of output containers in the form of cryogenic vials coupled thereto.

FIG. 4 is an isometric view of a collection of alternative single-use manifolds, according to other example embodiments, with a plurality of output containers in the form of cryogenic vials and bags shown in various quantities and sizes.

FIG. 5 is an isometric view of a collection of output containers in the form of vials of different sizes, according to another embodiment.

FIG. 6 is a perspective view of a system for aseptically transferring therapeutic fluid from an input container into a plurality of output containers, according to another example embodiment.

FIG. 7 is a front view of a single-use manifold including tubing and valving, according to one example embodiment, with a plurality of output containers in the form of cryogenic vials coupled thereto.

FIG. 8 is an isometric view of a collection of output containers in the form of cryogenic vials, according to another embodiment.

FIG. 9 is an isometric view of a collection of output containers in the form of cryogenic vials, according to yet another embodiment.

FIG. 10 are isometric views of an output container in the form of a cryogenic vial, according to another embodiment, shown in different configurations.

FIG. 11 is an isometric view of an output container in the form of a cryogenic vial, according to yet another embodiment.

FIG. 12 is an isometric view of a manifold and a plurality of output containers in the form of cryogenic vials coupled to the manifold, according to another example embodiment.

FIG. 13 is an enlarged partial isometric view of the manifold and output containers of FIG. 12, illustrating the use of pinch valves for controlling the flow of therapeutic fluid from the manifold into the output containers.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known devices, structures and techniques associated with fluid transfer systems, components thereof and related fluid transfer methods and techniques may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

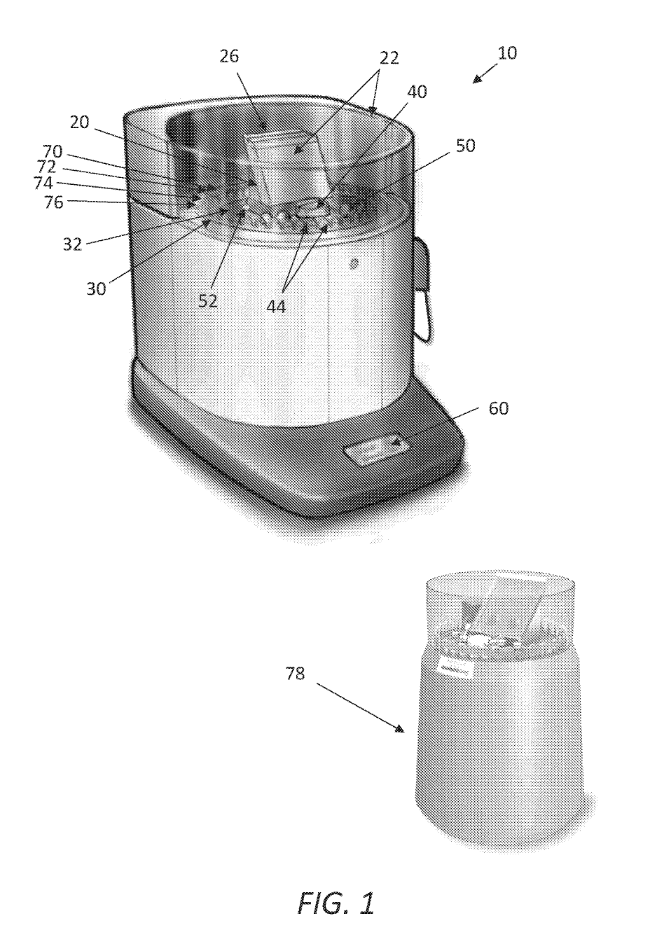

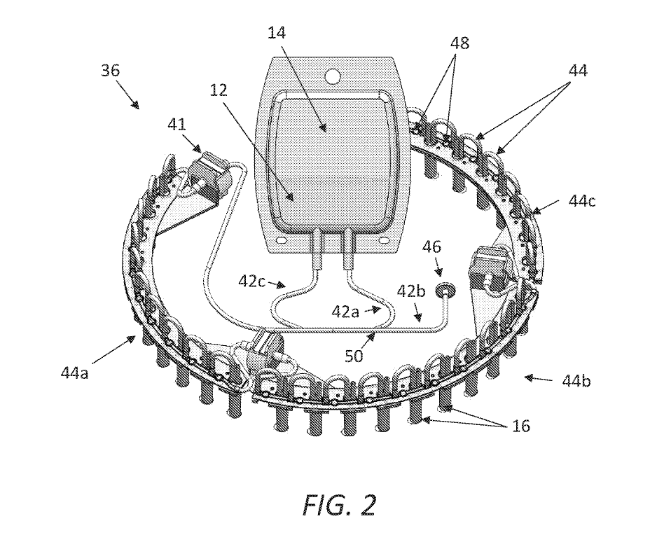

FIG. 1 illustrates a fluid transfer system 10 for aseptically transferring therapeutic fluid 12 (FIG. 2) from an input container 14 (FIG. 2) into a plurality of output containers 16 (FIG. 2), according to one example embodiment.

As shown in the example embodiment of FIG. 1, the fluid transfer system 10 includes an input fixture 20 configured to receive the input container 14 during a fluid transfer procedure. In some instances, the input fixture 20 may include a temperature control device, such as, for example, refrigerated enclosures 22, to adjust or maintain a temperature of the therapeutic fluid 12 within the input container 14 within a desired temperature range. For example, when transferring certain therapeutic fluids comprising mammalian cells suspended in a cryoprotectant solution, the temperature of the therapeutic fluid 12 within the input container 14 may be maintained between about 2° C. to about 8° C. by the temperature control device. For this purpose, the temperature control device may include or otherwise operate in conjunction with at least one temperature sensor to provide temperature feedback control functionality. The input fixture 20 may further include a mixing mechanism (not shown), such as, for example, a vibrator, agitator or shaker device, or a fluid circulation circuit, to homogenize the therapeutic fluid 12 within the input container 14 to assist in ensuring substantial homogenization of the therapeutic fluid 12 prior to and during transfer. The input fixture 20 may further include an attachment or coupling structure 26 for temporarily receiving and supporting the input container 14 during the fluid transfer procedure. The input fixture 20 may be selectively configurable for different types or sizes of input containers 14. For example, the input fixture 20 may include a first configuration to receive input containers 14 in the form of flexible solution containers (e.g., bags) of differing capacities (e.g., 750 ml, 1000 ml) and may include a second configuration to receive input containers 14 in the form of rigid solution containers (e.g., canisters) of differing capacities (e.g., 750 ml, 1000 ml). The input fixture 20 may be readily convertible between the first and second configurations, or may be adapted to interchangeably receive different types and sizes of input containers 14 without modification. The input fixture 20 may further include an integrated balance (not shown) for measuring the weight of the input container 14 from which to calculate starting volume, flow rate into or out of the input container during operation, and/or ending volume, and/or for monitoring the system for proper operation

With continued reference to FIG. 1, the fluid transfer system 10 further includes an output fixture 30 configured to receive the plurality of output containers 16. The output fixture 30 may include a temperature control device, such as, for example, a cooling plate 32, to adjust or maintain the temperature of the therapeutic fluid 12 deposited in the plurality of output containers 16 during the transfer procedure. For example, when transferring certain therapeutic fluids comprising mammalian cells suspended in a cryoprotectant solution, the temperature of the therapeutic fluid 12 deposited into the output containers 16 may be maintained between about 2° C. and about 8° C. by the temperature control device of the output fixture 30. The output fixture 30 may be configured to receive and support the output containers 16 during the transfer procedure. In addition, the output fixture 30 may be configured to receive and support a manifold 36, 37 such as a single-use manifold including tubing and valving, provided between the input container 14 and the output containers 16 to provide aseptic fluid communication between the same.

With continued reference to FIG. 1, an alternate device architecture and cosmetic design 78 is included for reference.

The output fixture 30 may be selectively configurable for different types or sizes of output containers 16. For example, the output fixture 30 may include a first configuration to receive output containers 16 in the form of flexible solution containers (e.g., bags) of differing capacities (e.g., 50 ml, 500 ml) and may include a second configuration to receive output containers 16 in the form of rigid solution containers (e.g., vials) of differing capacities (e.g., 1 ml, 2 ml, 3 ml, 4 ml, 5 ml). The output fixture 30 may be readily convertible between the first and second configurations, or may be adapted to interchangeably receive different types and sizes of output containers 16 without modification. In some embodiments, the output fixture 30 may include or otherwise accommodate one or more actuators or other mechanisms for automated manipulation of valving 48, 50 associated with the output containers 16. In other embodiments, the output fixture 30 may facilitate manual manipulation of valving 48, 50 associated with the output containers 16.

In some embodiments, the output containers 16 may be cryogenic storage compatible. In some embodiments, the output containers 16 may be preassembled to the manifold 36, 37 and the combination of the manifold 36, 37 and output containers 16 may be sold as a single-use kit for use in connection with the aseptic fluid transfer systems and methods described herein. Moreover, although the illustrated embodiment of FIG. 1 includes a single manifold 36, 37 connected to a plurality of output containers 16, it is appreciate that in some embodiments, a plurality of separate distinct manifolds 36, 37 may be coupled in fluid communication with the input container 14 in parallel. In addition, it is appreciated that the manifold 36, 37 may be provided in two or more parts coupled together in series to enable scaling of the output capacity. For example, sub-manifolds with a subset of output containers 16 may be provided and aseptically connected together as desired to adjust output capacity. Still further, one or more output containers 16 associated with the manifold 36, 37 may be disconnected or disabled prior to fluid transfer and replaced with smaller volume output containers 16 for reduced output capacity, or replaced with larger volume output containers 16 for increased capacity, or one or more additional output containers 16 may be added to the manifold 36, 37. In some instances, the plurality of output containers 16 may be identical, and in other instances, the output containers 16 may differ in size and/or shape and may vary in accordance with a predetermined dosing scheme.

The fluid transfer system 10 may further include a control module 40 to assist in moving the therapeutic fluid 12 between the input container 14 and the output containers 16. For example, the control module 40 may include a fluid pump, such as a peristaltic pump, for moving the therapeutic fluid 12 between the input container 14 and the output containers 16. The control module 40 may further include one or more sensors for assisting in controlling the transfer procedure, ensuring proper function and/or providing quality control. For instance, the control module 40 may include an integrated sensor (e.g., optical sensor, electrical impedance sensor) that is configured to verify that a composition of the therapeutic fluid 12 being delivered to the output containers 16 is substantially homogenous within a defined range to ensure output container composition parity.

According to the illustrated embodiment shown in FIG. 1, the fluid transfer system 10 further includes a control system 60 that is communicatively coupled to components of the fluid transfer system 10 for controlling one or more aspects of the aseptic transfer of the therapeutic fluid 12 from the input container 14 into the plurality of output containers 16 via the manifold 36, 37. The control system 60 may generally include, without limitation, one or more computing devices, such as processors, microprocessors, digital signal processors (DSP), application-specific integrated circuits (ASIC), and the like. To store information, the control system 60 may also include one or more storage devices, such as volatile memory, non-volatile memory, read-only memory (ROM), random access memory (RAM), and the like. The storage devices can be coupled to the computing devices by one or more buses. The control system 60 may further include one or more input devices (e.g., displays, keyboards, touchpads, controller modules, or any other peripheral devices for user input) and output devices (e.g., displays screens, light indicators, printers, and the like). The control system 60 can store one or more programs for controlling the aseptic transfer of therapeutic fluid 12 from the input container 14 into the plurality of output containers 16 via the manifold 36, 37 in at least a partially automated manner.

For example, the control system 60 may be communicatively coupled to the mixing mechanism of the input fixture 20 and include programming to control the mixing mechanism to ensure substantial homogenization of the therapeutic fluid 12 prior to and during transfer. In some instances, the mixing mechanism may comprise a mechanical agitation device that rocks the input container 14 to mix the contents thereof, and the control system 60 may be configured to agitate the input container intermittently or continuously for a predetermined period of time prior to or during fluid transfer. In some instances, composition feedback may be provided and agitation of the input container 14 may be controlled in response thereto. In other instances, the mixing mechanism may comprise a fluid circulation circuit having a recirculating pump and a composition sensor positioned to sense the composition of the recirculating fluid which are configured to circulate the fluid until a signal of the composition sensor is consistent within a predetermined variance, at which point a valve may be opened to divert fluid to the output containers 16.

The control system 60 may also be communicatively coupled to the temperature control device(s) (e.g., refrigerated enclosure 22 or cooling plate of the input fixture 20 and/or the output fixture 30 to maintain the therapeutic fluid 12 transferred from the input container 14 to the output containers 16 within a desired temperature range (e.g., about 2° C. to about 8° for the transfer of a fluid comprising mammalian cells suspended in a cryoprotectant solution). The control system 60 may be coupled to one or more temperature sensors to receive feedback temperature data to assist in controlling the temperature control device(s) of the input fixture 20 and/or output fixture 30 based at least in part on the same.

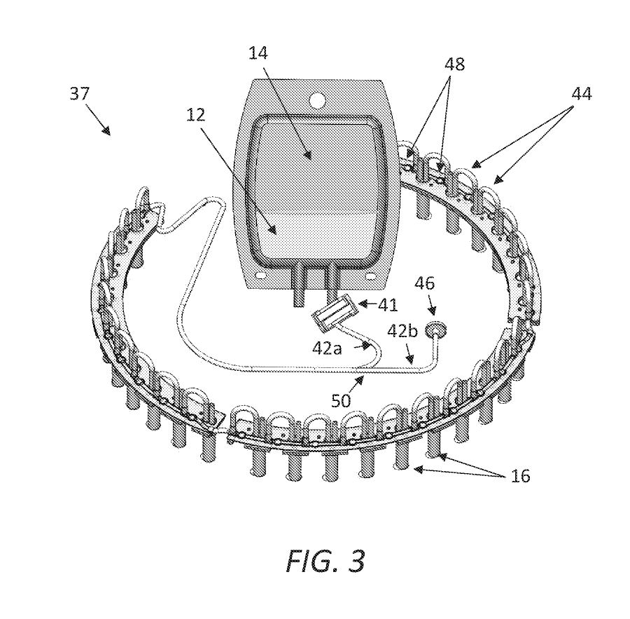

The control system 60 may be communicatively coupled to the control module 40 and may include programming to control the pump thereof for aseptically transferring fluid from the input container 14 into the plurality of output containers 16 via the manifold 36, 37. In some embodiments, including the example embodiment of FIG. 1 and example manifolds shown in FIGS. 2 and 3, the manifold 36, 37 may include selectable input branches 42a, 42b and selectable output branches 44 wherein one of the input branches 42a is in fluid communication with the fluid 12 of the input container 14 and another input branch 42b is in fluid communication with a buffer, such as, for example, a source of air via an air filter element 46. The control system 60 may be programmed to alternately pump the therapeutic fluid 12 and the buffer (e.g., air) by selectively switching between the selectable input branches 42a, 42b using one or more associated valves 50.

The manifold 36, 37 may further include an integrated mechanical module (not shown) provided for connecting the manifold 36, 37 to the input container 14 aseptically. As an example, the integrated mechanical module could be a tube welder that directly attaches tubing from the manifold 36, 37 to tubing associated with the input container 14. As another example, the integrated mechanical module could be a fixture that automates or manually assists the connection of a molded aseptic connector 41 provided at the end of the manifold 36, 37. When provided, the integrated mechanical module may be operably controlled by the control system 60. The control system 60 may also be communicatively coupled to at least one sensor, such as, for example, one or more pressure sensors 52, for monitoring or testing manifold pressure to ensure integrity of the connection prior to processing.

The control system 60 may also be communicatively coupled to at least one sensor, such as, for example, an optical sensor, for detecting a flow boundary of the therapeutic fluid 12 (e.g., leading boundary adjacent the preceding volume of buffer) to assist in determining fluid location inside the manifold 36, 37 and coordinating the delivery of each of the distinct defined volumes of the therapeutic fluid 12 with a respective one of the output containers 16. The control system 60 may be communicatively coupled to a plurality of valves 48 (e.g., stop cocks, pinch valves) or actuators therefor for selectively switching the output branches 44 to direct the distinct volumes of therapeutic fluid 12 into the output containers 16 with the result being that predetermined volumes (e.g., 10 ml) of the therapeutic fluid 12 are delivered to each of the output containers 16. Similarly, the control system 60 may be communicatively coupled to one or more valves 50 (e.g., stop cocks, pinch valves) or actuator(s) therefor for selectively switching the input branches 42a, 42b to create the distinct volumes of therapeutic fluid 12 separated by the buffer and controlling each respective volume of the therapeutic fluid 12. In some embodiments, the control system 60 may also include programming for pumping an initial volume of the therapeutic fluid 12 into the manifold 36, 37 prior to creating distinct defined volumes of the therapeutic fluid 12 to reduce fluid loss during transfer of the therapeutic fluid 12 from the input container 14 to the output containers 16. The valves 48, 50 may be sequenced to direct the distinct volumes of the therapeutic fluid 12 into the desired output containers in an orderly predetermined manner.

The control system 60 may also be communicatively coupled to at least one sensor, such as, for example, an optical sensor, for detecting whether the composition of the distinct volumes of the therapeutic fluid 12 delivered to the output containers 16 is substantially homogenous within a predetermined range to ensure output container composition parity, the composition sensor(s) being operable to quantify an attribute associated with the composition of the therapeutic fluid from outside of the container 16 or manifold 36, 37. In some instances, a single composition sensor may be provided upstream of the output containers 16 to sense the composition of the therapeutic fluid 12 as it is being delivered towards the output containers 16. In other instances, a separate composition sensor may be provided in connection with each of the output containers 16 to sense the composition of the therapeutic fluid 12 after is received by the output containers 16. Still further, a composition sensor may be provided such that, under the control of the control system 60, the output containers 16 are transported to the sensor to sense the composition of the therapeutic fluid 12 received by the output containers 16. In some instances, the control system 60 may be configured to compare a measured composition attribute from one output container 16 with a measurement or measurements from one or more other output containers 16 to verify substantial composition homogeneity between the output containers 16.

The control system 60 may also be communicatively coupled to at least one sensor 76 such as, for example, an optical sensor, for detecting a fluid level of the therapeutic fluid in each of the output containers 16 relative to a feature of the container 16 from outside of the container 16. In some instances, a separate fluid level sensor may be provided in connection with each of the output containers 16 to measure the fluid level in each container 16. In other instances, a fluid level sensor 76 may be provided such that, under the control of the control system 60, the output containers 16 are transported to the sensor to sense the level of the therapeutic fluid 12 received by the output containers 16. In either event, the control system 60 may be configured to calculate fluid volume based on input from the one or more fluid level sensors and physical attributes of the output container 16, and confirm the fluid volume is within a predetermined tolerance.

After the therapeutic fluid 12 is delivered to the output containers 16, the output containers 16 may be hermetically sealed and then stored for subsequent use, including storage in a cryogenic state. For this purpose, the fluid transfer system 10 may further include one or more integrated hermetic container sealing devices 74 such as, for example, a tube sealer device, a crimp device, a single use valve/closure or other device that is configured to selectively hermetically seal the plurality of output containers 16 after receipt of the therapeutic fluid 12 from the input container 14. As an example, the tube sealer device may be mounted such that, under the control of the control system 60, the output containers 16 are transported to the tube sealer for selective sealing of the output containers 16 with the distinct volumes of the therapeutic fluid 12 received therein. Sealing of the output containers 16 may occur after volume and composition verification steps are performed. In a similar manner, the fluid transfer system 10 may further include an integrated cutter device 72 or other device that is configured to cut or otherwise severe the output branch 44 at or upstream of the seal associated with each output container 16 to separate the output containers 16 from the manifold 36, 37 with the distinct volumes of therapeutic fluid 12 hermetically sealed therein.

The control system 60 may also be communicatively coupled to a detector 70 (e.g., laser code scanner) capable of detecting a unique container identifier of each output container 16. In this manner, the control system 60 may distinguish one output container 16 from other output containers and may associate various information therewith, including, for example, volume data and composition data relating to the volume and the composition of the therapeutic fluid 12 received therein. Other information that may be associated with the output container 16 includes patient data, date and time of storage, equipment identification data (e.g., equipment serial no.), single-use manifold lot number, and output container location on the manifold. The control system 60 may store such data and/or transmit the data to remote systems for various purposes.

The fluid transfer system 10 may further include one or more pressure sensors 52 to monitor manifold pressure to ensure integrity of the manifold 36, 37 and/or to confirm tube seal integrity via a leak test after sealing of the plurality of output containers 16. The one or more pressure sensors 52 may be provided in-line with or coupled to the manifold 36, 37 and may be communicatively coupled to the control system 60 such that the control system 60 may receive pressure signals indicative of a system leak or overpressure condition and provide an indication of the same and/or pause or terminate the transfer process until corrective action is taken.

FIG. 2 shows an example embodiment of a manifold 36 including tubing and branches and having a plurality of output containers 16 aseptically coupled thereto via aseptic connectors. The manifold 36 includes selectable input branches 42a, 42b and selectable output branches 44 via output valving 48 (e.g., pinch valves). The manifold 36 further includes a selectable recirculation branch 42c that can be used for pumping fluid 12 back into the input container 14 for the purposes of mixing. The manifold 36 further includes a first input branch 42a to be connected in fluid communication with the input container 14 and a second input branch 42b for fluid communication with a buffer (e.g., air). The manifold 36 further includes three main output groups 44a, 44b, 44c in fluid communication with the output containers via respective aseptic connectors 41. The output containers 16 provided in connection with the manifold 36 of the example embodiment of FIG. 2 are conventional cryogenic vials or cryovials, and include vents with respective air filters for maintaining an aseptic environment within the manifold 36, 37 and output containers 16. All connections of the manifold 36 and associated output containers 16 are made by way of aseptic connectors such that the entirety of the manifold assembly (inclusive of output containers 16) remains sterile. The manifold assembly may be enclosed in sterile packaging and sold as a single-use unit for use with the systems and methods described herein.

FIG. 3 shows an example embodiment of a manifold 37 including tubing and branches and having a plurality of output containers 16 aseptically coupled thereto via an aseptic connector 41. The manifold 37 includes selectable input branches 42a, 42b and selectable output branches 44 via output valving 48 (e.g., pinch valves). The manifold 37 further includes a first input branch 42a to be connected in fluid communication with the input container 14 and a second input branch 42b for fluid communication with a buffer (e.g., air). The output containers 16 provided in connection with the manifold 37 of the example embodiment of FIG. 3 are conventional cryogenic vials or cryovials, and include vents with respective air filters for maintaining an aseptic environment within the manifold 37 and output containers 16. All connections of the manifold 37 and associated output containers 16 are made by way of aseptic connectors such that the entirety of the manifold assembly (inclusive of output containers 16) remains sterile. The manifold assembly may be enclosed in sterile packaging and sold as a single-use unit for use with the systems and methods described herein.

In accordance with the example embodiment of the fluid transfer system 10 of FIG. 1 and the example embodiment of the manifold 36, 37 and output containers 16 of FIG. 2 and FIG. 3, which includes selectable input branches 42a, 42b and output branches 44 wherein a first input branch 42a is in fluid communication with the input container 14 and a second input branch 42b is in fluid communication with a buffer (e.g., air), a method for aseptic transfer of therapeutic fluid 12 from an input container 14 to the output containers 16 may be provided, which includes: aseptically connecting the input container 14 to the plurality of output containers 16 via the manifold 36, 37; pumping the therapeutic fluid 12; detecting a fill parameter of the therapeutic fluid 12 at the output container to determine when the container is filled; and selectively switching the output branches to direct the therapeutic fluid 12 into the plurality of output containers 16 with the result being that predetermined volumes of the therapeutic fluid 12 are delivered to the output containers 16.

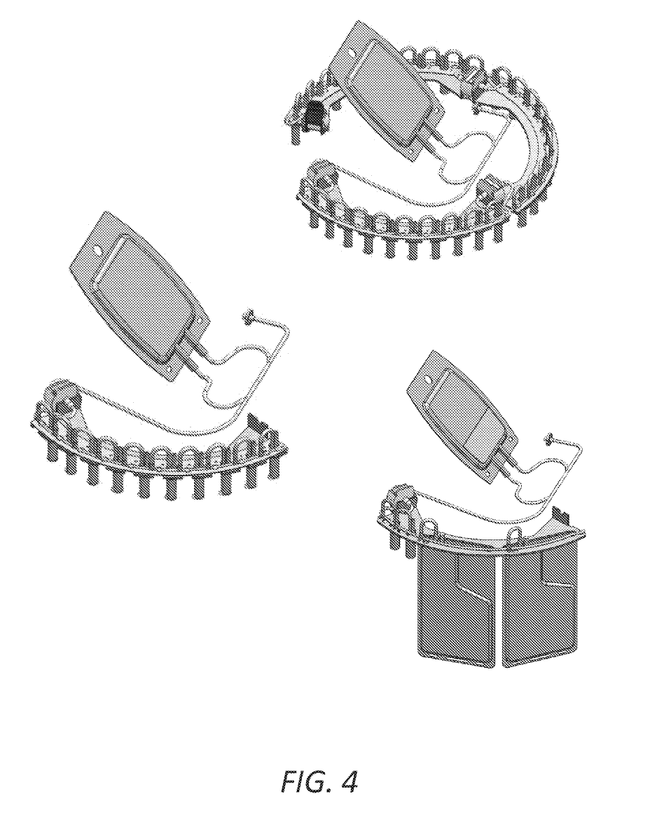

FIG. 4 shows a collection of alternative single-use manifolds, according to other example embodiments, having a plurality of output containers in the form of cryogenic vials and bags shown in various quantities and sizes.

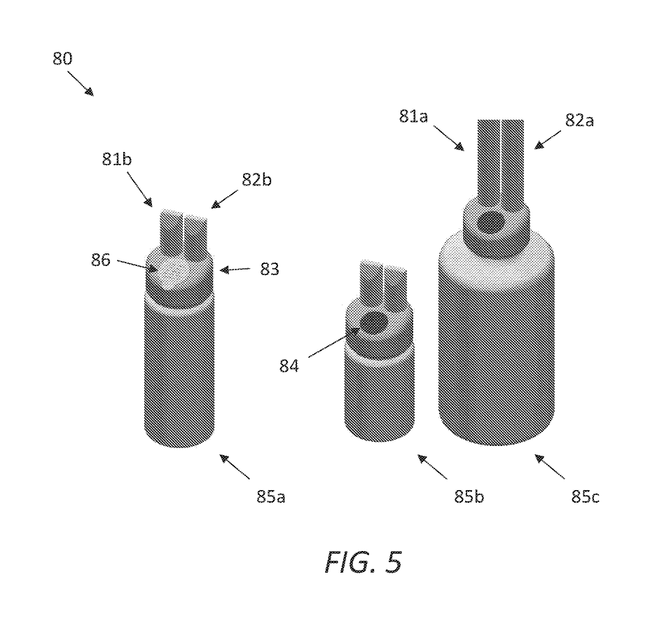

FIG. 5 illustrates an output container 80 according to another example embodiment in which the container is in communication with a fluid delivery manifold via flexible tubing 81a. An additional piece of flexible tubing 82a acts as a vent to facilitate filling of the vial and includes an integrated sterile filter, not shown. The flexible tubing 81a, 82a shown in this example is connected to the vial cap 83 which can be used with multiple output container bases 85a, 85b, 85c to accommodate different fluid volumes. The vial cap 83 includes an integrated septum 84 to facilitate fluid removal via needle or other mechanical devices. Additionally, a septum cover 86 protects the septum 84 from damage prior to fluid removal. After vial filling is complete the tubing can be mechanically sealed, using for example radio frequency or heat, at which point the containers may be separated from the manifold by cutting the tubing 81b, 82b.

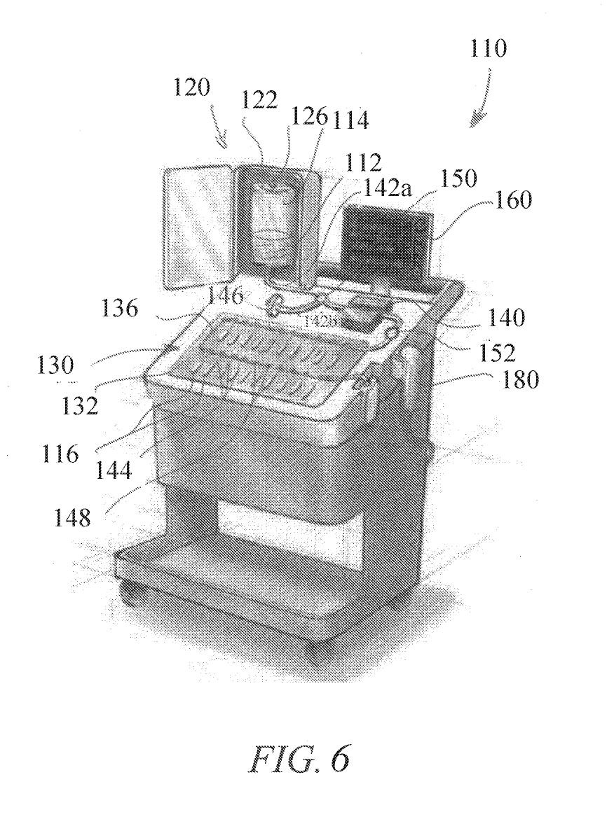

FIG. 6 illustrates a fluid transfer system 110 for aseptically transferring therapeutic fluid 112 from an input container 114 into a plurality of output containers 116, according to another example embodiment.

As shown in the example embodiment of FIG. 6, the fluid transfer system 110 includes an input fixture 120 configured to receive the input container 114 during a fluid transfer procedure. In some instances, the input fixture 120 may include a temperature control device, such as, for example, a refrigerated enclosure 122, to adjust or maintain a temperature of the therapeutic fluid 112 within the input container 114 within a desired temperature range. For example, when transferring certain therapeutic fluids comprising mammalian cells suspended in a cryoprotectant solution, the temperature of the therapeutic fluid 112 within the input container 114 may be maintained between about 2° C. to about 8° C. by the temperature control device. For this purpose, the temperature control device may include or otherwise operate in conjunction with at least one temperature sensor to provide temperature feedback control functionality. The input fixture 120 may further include a mixing mechanism (not shown), such as, for example, a vibrator, agitator or shaker device, or a fluid circulation circuit, to homogenize the therapeutic fluid 112 within the input container 114 to assist in ensuring substantial homogenization of the therapeutic fluid 112 prior to and during transfer. The input fixture 120 may further include an attachment or coupling structure 126 for temporarily receiving and supporting the input container 114 during the fluid transfer procedure. The input fixture 120 may be selectively configurable for different types or sizes of input containers 114. For example, the input fixture 120 may include a first configuration to receive input containers 114 in the form of flexible solution containers (e.g., bags) of differing capacities (e.g., 750 ml, 1000 ml) and may include a second configuration to receive input containers 114 in the form of rigid solution containers (e.g., canisters) of differing capacities (e.g., 750 ml, 1000 ml). The input fixture 120 may be readily convertible between the first and second configurations, or may be adapted to interchangeably receive different types and sizes of input containers 114 without modification. The input fixture 120 may further include an integrated balance (not shown) for measuring the weight of the input container 114 from which to calculate starting volume, flow rate into or out of the input container during operation, and/or ending volume, and/or for monitoring the system for proper operation

With continued reference to FIG. 6, the fluid transfer system 110 further includes an output fixture 130 configured to receive the plurality of output containers 116. The output fixture 130 may include a temperature control device, such as, for example, a cooling plate 132, to adjust or maintain the temperature of the therapeutic fluid 112 deposited in the plurality of output containers 116 during the transfer procedure. For example, when transferring certain therapeutic fluids comprising mammalian cells suspended in a cryoprotectant solution, the temperature of the therapeutic fluid 112 deposited into the output containers 116 may be maintained between about 2° C. and about 8° C. by the temperature control device of the output fixture 130. The output fixture 130 may be configured to receive and support the output containers 116 during the transfer procedure. In addition, the output fixture 130 may be configured to receive and support a manifold 136, such as a single-use manifold including tubing and valving, provided between the input container 114 and the output containers 116 to provide aseptic fluid communication between the same.

The output fixture 130 may be selectively configurable for different types or sizes of output containers 116. For example, the output fixture 130 may include a first configuration to receive output containers 116 in the form of flexible solution containers (e.g., bags) of differing capacities (e.g., 50 ml, 500 ml) and may include a second configuration to receive output containers 116 in the form of rigid solution containers (e.g., vials) of differing capacities (e.g., 1 ml, 2 ml, 3 ml, 4 ml, 5 ml). The output fixture 30 may be readily convertible between the first and second configurations, or may be adapted to interchangeably receive different types and sizes of output containers 116 without modification. In some embodiments, the output fixture 130 may include or otherwise accommodate one or more actuators or other mechanisms for automated manipulation of valving 150 associated with the output containers 116. In other embodiments, the output fixture 130 may facilitate manual manipulation of manipulation of valving 150 associated with the output containers 116.

In some embodiments, the output containers 116 may be cryogenic storage compatible. In some embodiments, the output containers 116 may be preassembled to the manifold 136 and the combination of the manifold 136 and output containers 116 may be sold as a single-use kit for use in connection with the aseptic fluid transfer systems and methods described herein. Moreover, although the illustrated embodiment of FIG. 6 includes a single manifold 136 connected to a plurality of output containers 116, it is appreciate that in some embodiments, a plurality of separate distinct manifolds may be coupled in fluid communication with the input container 114 in parallel. In addition, it is appreciated that the manifold 136 may be provided in two or more parts coupled together in series to enable scaling of the output capacity. For example, sub-manifolds with a subset of output containers 116 may be provided and aseptically connected together as desired to adjust output capacity. Still further, one or more output containers 116 associated with the manifold 136 may be disconnected or disabled prior to fluid transfer and replaced with smaller volume output containers 116 for reduced output capacity, or replaced with larger volume output containers 116 for increased capacity, or one or more additional output containers 116 may be added to the manifold 136. In some instances, the plurality of output containers 116 may be identical, and in other instances, the output containers 116 may differ in size and/or shape and may vary in accordance with a predetermined dosing scheme.

The fluid transfer system 110 may further include a control module 140 to assist in moving the therapeutic fluid 112 between the input container 114 and the output containers 116. For example, the control module 140 may include a fluid pump, such as a peristaltic pump, for moving the therapeutic fluid 112 between the input container 114 and the output containers 116. The control module 140 may further include one or more sensors for assisting in controlling the transfer procedure, ensuring proper function and/or providing quality control. For instance, the control module 140 may include an integrated sensor (e.g., optical sensor, electrical impedance sensor) that is configured to verify that a composition of the therapeutic fluid 112 being delivered to the output containers 116 is substantially homogenous within a defined range to ensure output container composition parity.

According to the illustrated embodiment shown in FIG. 6, the fluid transfer system 110 further includes a control system 160 that is communicatively coupled to components of the fluid transfer system 110 for controlling one or more aspects of the aseptic transfer of the therapeutic fluid 112 from the input container 114 into the plurality of output containers 116 via the manifold 136. The control system 160 may generally include, without limitation, one or more computing devices, such as processors, microprocessors, digital signal processors (DSP), application-specific integrated circuits (ASIC), and the like. To store information, the control system 160 may also include one or more storage devices, such as volatile memory, non-volatile memory, read-only memory (ROM), random access memory (RAM), and the like. The storage devices can be coupled to the computing devices by one or more buses. The control system 60 may further include one or more input devices (e.g., displays, keyboards, touchpads, controller modules, or any other peripheral devices for user input) and output devices (e.g., displays screens, light indicators, and the like). The control system 160 can store one or more programs for controlling the aseptic transfer of therapeutic fluid 112 from the input container 114 into the plurality of output containers 116 via the manifold 136 in at least a partially automated manner.

For example, the control system 160 may be communicatively coupled to the mixing mechanism of the input fixture 120 and include programming to control the mixing mechanism to ensure substantial homogenization of the therapeutic fluid 112 prior to and during transfer. In some instances, the mixing mechanism may comprise a mechanical agitation device that rocks the input container 114 to mix the contents thereof, and the control system 160 may be configured to agitate the input container intermittently or continuously for a predetermined period of time prior to or during fluid transfer. In some instances, composition feedback may be provided and agitation of the input container 114 may be controlled in response thereto. In other instances, the mixing mechanism may comprise a fluid circulation circuit having a recirculating pump and a composition sensor positioned to sense the composition of the recirculating fluid which are configured to circulate the fluid until a signal of the composition sensor is consistent within a predetermined variance, at which point a valve may be opened to divert fluid to the output containers 116.

The control system 160 may also be communicatively coupled to the temperature control device(s) (e.g., refrigerated enclosure 122 or cooling plate 132) of the input fixture 120 and/or the output fixture 130 to maintain the therapeutic fluid 112 transferred from the input container 114 to the output containers 116 within a desired temperature range (e.g., about 2° C. to about 8° for the transfer of a fluid comprising mammalian cells suspended in a cryoprotectant solution). The control system 160 may be coupled to one or more temperature sensors to receive feedback temperature data to assist in controlling the temperature control device(s) of the input fixture 120 and/or output fixture 130 based at least in part on the same.

The control system 160 may be communicatively coupled to the control module 140 and may include programming to control the pump thereof for aseptically transferring fluid from the input container 114 into the plurality of output containers 116 via the manifold 136. In some embodiments, including the example embodiment of FIG. 6, the manifold 136 may include selectable input branches 142a, 142b and selectable output branches 144 wherein one of the input branches 142a is in fluid communication with the fluid 112 of the input container 114 and another input branch 142b is in fluid communication with a buffer that is immiscible with the therapeutic fluid 112, such as, for example, a source of air via an air filter element 146. The control system 160 may be programmed to alternately pump the therapeutic fluid 112 and the buffer (e.g., air) by selectively switching between the selectable input branches 142a, 142b using one or more associated valves 150 to create distinct defined volumes of the therapeutic fluid 112 separated by distinct defined volumes of the buffer.

The manifold 136 may further include an integrated mechanical module (not shown) provided for connecting the manifold 136 to the input container 114 aseptically. As an example, the integrated mechanical module may be a tube welder that directly attaches tubing from the manifold 136 to tubing associated with the input container 114. As another example, the integrated mechanical module may be a fixture that automates or manually assists the connection of a molded aseptic connector 141 provided at the end of the manifold 136. When provided, the integrated mechanical module may be operably controlled by the control system 160. The control system 160 may also be communicatively coupled to at least one sensor, such as, for example, one or more pressure sensors 152, for monitoring or testing manifold pressure to ensure integrity of the connection prior to processing.

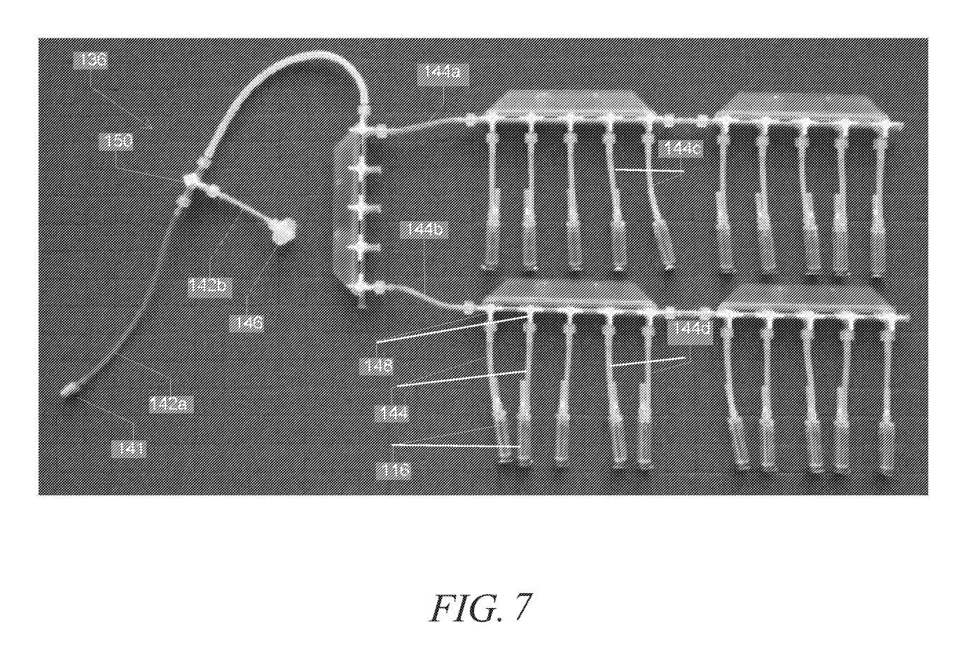

The control system 160 may also be communicatively coupled to at least one sensor, such as, for example, an optical sensor, for detecting a flow boundary of the therapeutic fluid 112 (e.g., leading boundary adjacent the preceding volume of buffer) to assist in determining fluid location inside the manifold 136 and coordinating the delivery of each of the distinct defined volumes of the therapeutic fluid 112 with a respective one of the output containers 116. The control system 160 may be communicatively coupled to a plurality of valves 148 (e.g., stop cocks, pinch valves) or actuators therefor for selectively switching the output branches 144 to direct the distinct volumes of therapeutic fluid 112 into the output containers 116 with the result being that predetermined volumes (e.g., 10 ml) of the therapeutic fluid 112 are delivered to each of the output containers 116. Similarly, the control system 160 may be communicatively coupled to one or more valves 150 (e.g., stop cocks, pinch valves) or actuator(s) therefor for selectively switching the input branches 142a, 142b to create the distinct volumes of therapeutic fluid 112 separated by the buffer and controlling each respective volume of the therapeutic fluid 112. In some embodiments, the control system 160 may also include programming for pumping an initial volume of the therapeutic fluid 112 into the manifold 136 prior to creating distinct defined volumes of the therapeutic fluid 112 to reduce fluid loss during transfer of the therapeutic fluid 112 from the input container 114 to the output containers 116. The valves 148, 150 may be sequenced to direct the distinct volumes of the therapeutic fluid 112 into the desired output containers in an orderly predetermined manner. For example, with reference to the example manifold 136 and associated output containers 116 coupled thereto shown in FIG. 7, the valves may be sequenced to sequentially fill a lower branch or subset of the output containers 116 from right to left and then fill an upper branch or subset of the output containers 116 from right to left.

The control system 160 may also be communicatively coupled to at least one sensor, such as, for example, an optical sensor, for detecting whether the composition of the distinct volumes of the therapeutic fluid 112 delivered to the output containers 116 is substantially homogenous within a predetermined range to ensure output container composition parity, the composition sensor(s) being operable to quantify an attribute associated with the composition of the therapeutic fluid from outside of the container 116 or manifold 136. In some instances, a single composition sensor may be provided upstream of the output containers 116 to sense the composition of the therapeutic fluid 112 as it is being delivered towards the output containers 116. In other instances, a separate composition sensor may be provided in connection with each of the output containers 116 to sense the composition of the therapeutic fluid 112 after is received by the output containers 116. Still further, a composition sensor may be provided on a movable sensor head to move under the control of the control system 160 to sense the composition of the therapeutic fluid 112 received by the output containers 116 by moving the sensor head adjacent to each output container 116 to be measured. In some instances, the control system 160 may be configured to compare a measured composition attribute from one output container 116 with a measurement or measurements from one or more other output containers 116 to verify substantial composition homogeneity between the output containers 116.

The control system 160 may also be communicatively coupled to at least one sensor (not shown), such as, for example, an optical sensor, for detecting a fluid level of the therapeutic fluid in each of the output containers 116 relative to a feature of the container 116 from outside of the container 116. In some instances, a separate fluid level sensor may be provided in connection with each of the output containers 116 to measure the fluid level in each container 116. In other instances, a fluid level sensor may be provided on a movable sensor head to move under the control of the control system 160 to measure the fluid level of the therapeutic fluid 112 received in each of the output containers 116 by moving the sensor head adjacent to each output container 116 to be measured. In either event, the control system 160 may be configured to calculate fluid volume based on input from the one or more fluid level sensors and physical attributes of the output container 116, and confirm the fluid volume is within a predetermined tolerance.

After the therapeutic fluid 112 is delivered to the output containers 116, the output containers 116 may be hermetically sealed and then stored for subsequent use, including storage in a cryogenic state. For this purpose, the fluid transfer system 110 may further include one or more integrated hermetic container sealing devices (not shown), such as, for example, a tube sealer device, a crimp device, a single use valve/closure or other device that is configured to selectively hermetically seal the plurality of output containers 116 after receipt of the therapeutic fluid 112 from the input container 114. As an example, the tube sealer device may be mounted on a movable sealing head to move under the control of the control system 160 to selectively seal the output containers 116 with the distinct volumes of the therapeutic fluid 112 received therein. Sealing of the output containers 116 may occur after volume and composition verification steps are performed. In a similar manner, the fluid transfer system 110 may further include an integrated cutter device (not shown) or other device that is configured to cut or otherwise severe the output branch 144 at or upstream of the seal associated with each output container 116 to separate the output containers 116 from the manifold 136 with the distinct volumes of therapeutic fluid 112 hermetically sealed therein.

The control system 160 may also be communicatively coupled to a detector 180 (e.g., laser code scanner) capable of detecting a unique container identifier of each output container 116. In this manner, the control system 160 may distinguish one output container 116 from other output containers and may associate various information therewith, including, for example, volume data and composition data relating to the volume and the composition of the therapeutic fluid 112 received therein. Other information that may be associated with the output container 116 includes patient data, date and time of storage, equipment identification data (e.g., equipment serial no.), single-use manifold lot number, and output container location on the manifold. The control system 160 may store such data and/or transmit the data to remote systems for various purposes.

The fluid transfer system 110 may further include one or more pressure sensors 152 to monitor manifold pressure to ensure integrity of the manifold 136 and/or to confirm tube seal integrity via a leak test after sealing of the plurality of output containers 116.

The one or more pressure sensors 152 may be provided in-line with or coupled to the manifold 136 and may be communicatively coupled to the control system 160 such that the control system 160 may receive pressure signals indicative of a system leak or overpressure condition and provide an indication of the same and/or pause or terminate the transfer process until corrective action is taken.

FIG. 7 shows an example embodiment of a manifold 136 including tubing and valving and having a plurality of output containers 116 aseptically coupled thereto via aseptic connectors. The manifold 136 includes selectable input branches 142a, 142b via input valving 150 (e.g., stop cocks, pinch valves) and selectable output branches 144 via output valving 148 (e.g., stop cocks, pinch valves). The manifold 136 further includes a first input branch 142a to be connected in fluid communication with the input container 114 and a second input branch 142b for fluid communication with a buffer (e.g., air) that is immiscible with the therapeutic fluid 112 to be transferred. For example, the second input branch 142b is in fluid communication with the surrounding air environment via an air filter element 146. The manifold 136 further includes two main output branches 144a, 144b, and a respective set of sub-branches 144c, 144d in fluid communication with the output containers via respective valving 150. The output containers 116 provided in connection with the manifold 136 of the example embodiment of FIG. 7 are conventional cryogenic vials or cryovials, and include vents with respective air filters for maintaining an aseptic environment within the manifold 136 and output containers 116. All connections of the manifold 136 and associated output containers 116 are made by way of aseptic connectors such that the entirety of the manifold assembly (inclusive of output containers 116) remains sterile. The manifold assembly may be enclosed in sterile packaging and sold as a single-use unit for use with the systems and methods described herein.

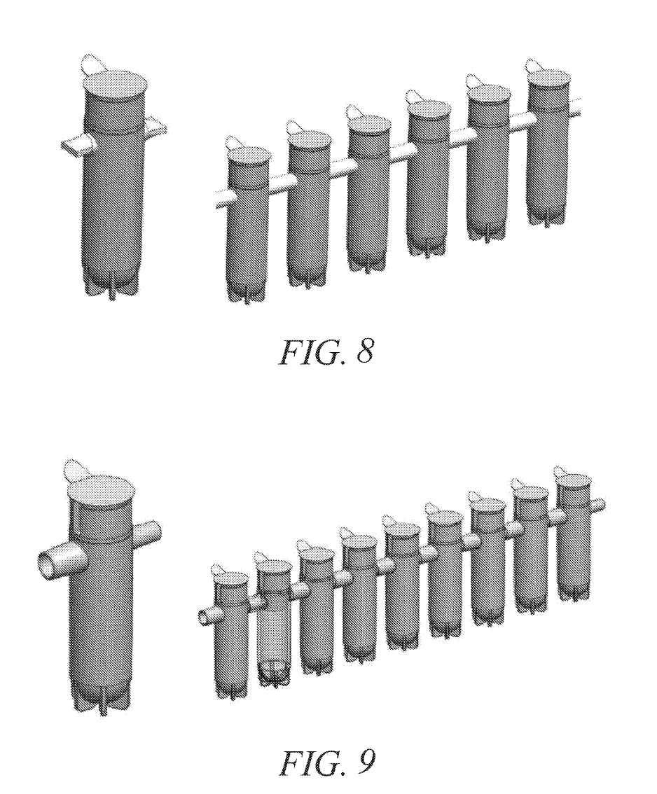

FIG. 8 illustrates a collection of output containers according to another example embodiment in which adjacent containers are attached together in series with flexible tubing formed integrally therewith. In such instances, the therapeutic fluid may be introduced into a leading one of the containers and each subsequent container may be filled as the fluid level in a preceding container reaches the adjoining flexible tubing and overflows into the next container. Once all of the therapeutic fluid is transferred, the containers may be sealed and separated from each other using, for example, a tube sealer and cutter device.

FIG. 9 illustrates a collection of output containers according to another example embodiment in which adjacent containers are attached together in series with interlocking or engageable conduit sections formed integrally with each container. In such instances, the therapeutic fluid may be introduced into a leading one of the containers and each subsequent container may be filled as the fluid level in a preceding container reaches the adjoining conduit sections and overflows into the next container. Once all of the therapeutic fluid is transferred, the containers may be sealed and separated from each other.

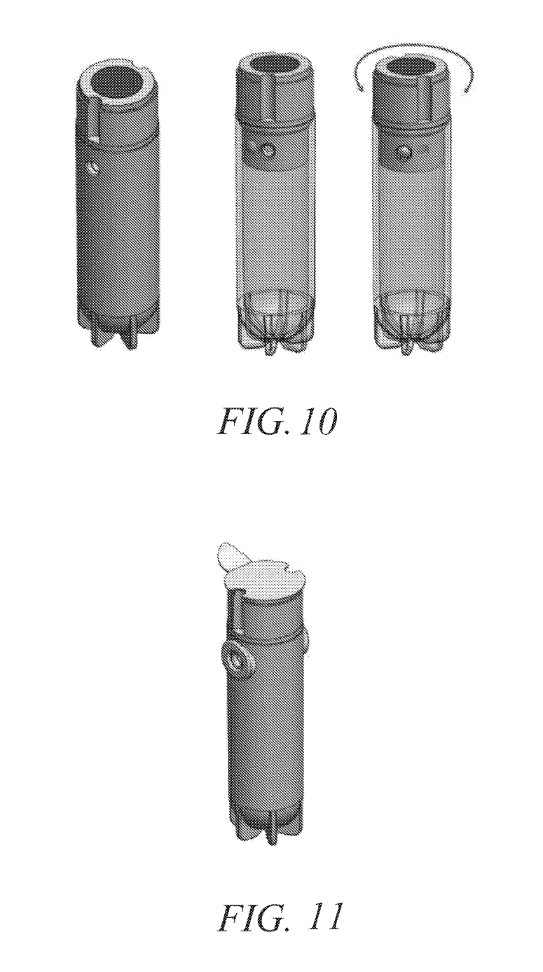

FIG. 10 illustrates an output container according to another example embodiment in which an inlet passage for receiving the therapeutic fluid is selectively closable by rotating a base portion of the container relative to a head portion thereof. In such instances, an associated fluid transfer system may be configured to manipulate the base or head portion relative to the other portion after the container receives a predetermined volume of the therapeutic fluid to close the inlet passage and seal the fluid within the container for subsequent storage and use. Accordingly, features may be provided on the base portion and the head portion for facilitating manipulation of the same relative to each other.

FIG. 11 illustrates an output container according to yet another example embodiment in which fluid receiving apertures are provided in an upper portion of the container having associated compliant sealing surfaces. Like containers (e.g., vials) can be connected in series, either with a fixture or with additional features on the containers, and fluid may then flow between the containers while the fluid receiving apertures are open. After filling, a cap portion of each container may be actuated (similar to the movement illustrated in FIG. 10) to seal fluid in each container and then the containers may be separated from each other. In some instances, the fluid receiving apertures may be configured for insertably receiving a corresponding tube or other conduit for enabling the containers to be aseptically connected together and selectively filled with therapeutic fluid from a common input container. In this manner, the containers may be combined with like containers as desired to accommodate the transfer of a particular volume of fluid to be transferred.

In accordance with the example embodiment of the fluid transfer system 110 of FIG. 6 and the example embodiment of the manifold 136 and output containers 116 of FIG. 7, which includes selectable input branches 142a, 142b and output branches 144 wherein a first input branch 142a is in fluid communication with the input container 114 and a second input branch 142b is in fluid communication with a buffer (e.g., air) that is immiscible with the therapeutic fluid to be transferred, a method for aseptic transfer of therapeutic fluid 112 from an input container 114 to the output containers 116 may be provided, which includes: aseptically connecting the input container 14 to the plurality of output containers 116 via the manifold 136; alternately pumping the therapeutic fluid 112 and the buffer by selectively switching between the first and second input branches 142a, 142b, thereby creating distinct defined volumes of the therapeutic fluid 112 separated by distinct defined volumes of the buffer; detecting a flow boundary of the therapeutic fluid 112 to assist in determining fluid location inside the manifold 136; and selectively switching the output branches to direct the distinct volumes of therapeutic fluid 112 into the plurality of output containers 116 with the result being that predetermined volumes of the therapeutic fluid 112 are delivered to the output containers 116.

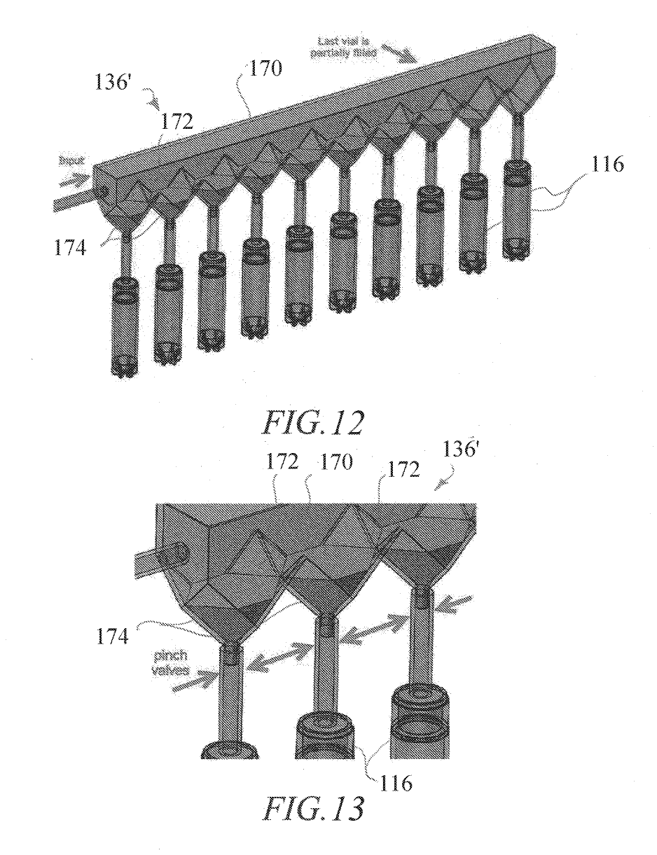

Although the aforementioned method of transferring therapeutic fluid is described as including the pumping of discrete volumes of the therapeutic fluid 112 by alternately pumping therapeutic fluid 112 and a buffer, it is appreciated that other methods and techniques may be used to move therapeutic fluid 112 from an input container 114 to a plurality of output containers 116. For example, a method for aseptic transfer of therapeutic fluid 112 from an input container 114 to a plurality of output containers 116 according to another embodiment may, with reference to FIGS. 12 and 13, include aseptically connecting the input container 112 to the plurality of output containers 116 via a manifold 136′, wherein the manifold 136′ contains a reservoir 170 with a plurality of partitions 172 which create a series of defined-volume fluid basins 174, each of which is connected to a respective output container 116 via a respective fluid outlet valve (not shown). The method may further include pumping the therapeutic fluid 112 into the manifold 136′ at a controlled rate allowing each fluid basin 174 to fill and overflow a respective one of the partitions 172 into a successive one of the fluid basins 174 until the entirety of the therapeutic fluid 112 is delivered into the reservoir 170, or until a desired number of the fluid basins 174 are filled. The method may then continue by selectively opening the fluid output valves (e.g., pinch valves at locations shown in FIG. 13) associated with each filled fluid basin 174, allowing the defined-volumes of fluid 112 in the fluid basins 174 to move from the fluid basins 174 into the output containers 116. In some instances, the method may further include pressurizing the reservoir 170 to ensure proper movement of the therapeutic fluid 112 from the fluid basins 174 into the plurality of output containers 116. Once the fluid transfer is complete, the output containers 116 may be sealed and separated from the manifold 136′ for subsequent storage and use.

Although the systems and methods described herein are predominately discussed in the context of transferring therapeutic fluids into output containers for cryogenic storage, it is appreciated that in other instances aspects of the systems and methods may be used with other types of fluids and for other purposes, including fluids which may not have therapeutic applications or which are not intended to be cryogenically stored.

Moreover, aspects and features of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for aseptic transfer of fluid from an input container to a plurality of output containers, the method comprising:
aseptically connecting the input container to the plurality of output containers via a manifold which includes selectable output branches;
pumping the fluid to the output containers while monitoring one or more fill parameters such that the fill process is ended when a predetermined fill value is reached; and
selectively opening and closing output branches such that fluid is pumped to other output containers using the same fill parameter feedback control.

2. The method of claim 1 wherein the fluid comprises mammalian cells suspended in a cryoprotectant solution.

3. The method of claim 1 wherein the manifold is a single-use manifold including tubing.

4. The method of claim 1 wherein the output containers are cryogenic storage compatible.

5. The method of claim 1 wherein the output containers are preassembled to the manifold.

6. The method of claim 1, further comprising: aseptically connecting the input container to an additional plurality of output containers.

7. The method of claim 1, further comprising: connecting one or more additional output containers to the manifold or disconnecting one or more of the output containers from the manifold to vary a configuration of the fluid transfer.

8. The method of claim 1 wherein only one output container is filled at a time.

9. The method of claim 1 wherein the inlet branches and outlet branches are selectable through the use of at least one of mechanical valves, stopcocks and pinch valves.

10. The method of claim 1 wherein the fill parameter is fluid volume as observed by fluid height in the output container.

11. The method of claim 1 wherein the fill parameter is based on output container weight.

12. The method of claim 1, further comprising: reversing the pump in order to recover fluid from an output manifold branch for transfer to an alternate output container.

13. The method of claim 1, further comprising: mixing the fluid in the input container by pumping the fluid through a recirculating loop.

14. The method of claim 1, further comprising: monitoring the fluid with a sensor to confirm that the fluid has reached a substantially homogenized state for transfer to the output containers.

15. The method of claim 1, further comprising: mixing the fluid in the input container by agitating the input container using mechanical paddles.

16. The method of claim 1, further comprising: selectively switching between a first fluid input branch and a second fluid input branch.

17. The method of claim 16 wherein a second input fluid from the second fluid branch is mixed with the first input fluid.

18. The method of claim 17 wherein the second input fluid is a cryoprotectant.

19. The method of claim 1, further comprising: selectively switching between a fluid input branch and a gas input branch, and purging fluid from the manifold using gas input through the gas input branch.

20. The method of claim 19 wherein the gas input is filtered air.

21. A system for aseptically transferring fluid from an input container into a plurality of output containers, the system comprising:
a manifold which connects the input container to the output containers;
at least one pump;
a fixture configured to receive the input container and the output containers;
a mechanism to open or close defined manifold branches to allow or prevent fluid flow; and
a controller configured to control one or more aspects of the system to facilitate transfer of the fluid from the input container to the plurality of output containers.

22. The system of claim 21 wherein the at least one pump is a peristaltic pump.

23. The system of claim 21 wherein the controller is configured to operate a mixer to ensure homogenization of the fluid prior to and during transfer.

24. The system of claim 21 wherein the input fixture can accommodate different types or sizes of input containers.

25. The system of claim 21 wherein the input container is oriented such that an outlet port thereof is located at the lowest point such that gravity acts upon the fluid to move to the output containers.

26. The system of claim 21 wherein the output fixture can accommodate different types or sizes of output containers.

27. The system of claim 21 wherein the output containers are oriented such that an input port is located above the highest point of fluid fill such that gravity acts upon the fluid to move it away from the input port.

28. The system of claim 21, further comprising: a first temperature control device to adjust or maintain a temperature of the fluid within the input container.

29. The system of claim 28, further comprising: a second temperature control device to adjust or maintain a temperature of the fluid received in the plurality of output containers.

30. The system of claim 29 wherein the controller is configured to control the first and second temperature control devices to maintain a temperature of the fluid moving from the input container to the output containers within a temperature range of about 2° C. to about 8° C.

31. The system of claim 21 wherein the manifold contains a recirculating loop that allows for pumping of fluid back to the input container for purposes of mixing.

32. The system of claim 21, further comprising: an integrated sensor for monitoring one or more fluid properties in the recirculating loop to determine when the fluid has reached a homogenized state and can be transferred to the output containers.

33. The system of claim 133 wherein the output sensor is an optical sensor that detects fluid height in the output container.

34. The system of claim 133 wherein the output sensor is a scale that detects output container weight.

35. The system of claim 21, further comprising: a mixer that includes mechanical paddles which repeatedly deform the input container such that the fluid contained within the container is mixed.

36. The system of claim 21, further comprising: an integrated balance for measuring the weight of the input container from which to calculate starting volume, flow rate into or out of the input container, and/or ending volume, and/or for monitoring the system for proper operation.

37. The system of claim 21, further comprising: an integrated sensor configured to verify that the fluid in the output containers are substantially homogenous in composition within a defined range to ensure output container composition parity.

38. The system of claim 21, further comprising: an integrated hermetic container sealing device to selectively seal the plurality of output containers after fill completes.

39. The system of claim 21, further comprising: an integrated tube cutting system whereby the plurality of output containers can be separated from the manifold when the fluid transfer is complete.

40. The system of claim 21, further comprising: one or more pressure sensors to monitor manifold pressure to ensure integrity of the manifold and to confirm tube seal integrity via a leak test after sealing of the plurality of output containers.

41. The system of claim 133 wherein the output sensor is in a fixed location and the output containers are moved into proximity with the sensor for filling.

42. The system of claim 21 wherein the output containers are arranged in a circular pattern.

43. The system of claim 21, further comprising: a second input fixture configured to receive a second fluid input container to be mixed with the first input container prior to pumping to the output containers.

44. The system of claim 43 wherein a second input fluid from the second input fixture is a cryoprotectant.

45. A fluid storage device compatible with aseptic fluid transfer comprising:
a container having a top portion and a bottom portion, the bottom portion forming a cavity configured to hold fluid and the top portion configured to receive a cap assembly; and
the cap assembly, the cap assembly having a top and a bottom portion having respective openings and comprising: integrated tubing for closed communication with an input device; a vent with integrated sterile filter, a septum, and a sealing surface for aseptic connection to the container.

46. The device of claim 45 wherein the cap assembly is compatible with multiple fluid containers.

47. The device of claim 45 wherein the cap assembly includes a septum cover to protect the septum from damage prior to use.

48. The device of claim 45 wherein the tubing is mechanically sealable.

49. The device of claim 45 wherein the materials are compatible with cryogenic storage.

50-72. (canceled)

73. A method for aseptic transfer of fluid from an input container to a plurality of output containers, the method comprising:
aseptically connecting the input container to the plurality of output containers via a manifold, the manifold including selectable input branches and output branches wherein a first input branch is in fluid communication with the input container and a second input branch is in fluid communication with a buffer that is immiscible with the fluid to be transferred;
alternately pumping the fluid and the buffer by selectively switching between the first and second input branches, creating distinct defined volumes of the fluid separated by distinct defined volumes of the buffer; and
selectively switching the output branches to direct the distinct volumes of fluid into the plurality of output containers with the result being that predetermined volumes of the fluid are delivered to the output containers.

74. The method of claim 73 wherein the buffer is air.

75. The method of claim 73 wherein the fluid comprises mammalian cells suspended in a cryoprotectant solution.

76. The method of claim 73, further comprising:
pumping an initial volume of the fluid into the manifold prior to creating distinct defined volumes of the fluid to reduce fluid loss during transfer of the fluid between the input container and the output containers.

77. The method of claim 73 wherein the manifold is a single-use manifold including tubing.

78. The method of claim 73 wherein the output containers are cryogenic storage compatible.

79. The method of claim 73 wherein the output containers are preassembled to the manifold.

80. The method of claim 73, further comprising:
aseptically connecting the input container to an additional plurality of output containers via an additional manifold.

81. The method of claim 73, further comprising:
connecting one or more additional output containers to the manifold or disconnecting one or more of the output containers from the manifold to vary a configuration of the fluid transfer.

82. The method of claim 73 wherein the inlet branches and outlet branches are selectable through the use of at least one of stopcocks and pinch valves.

83-106. (canceled)

107. A system for detecting fluid volume and relative fluid composition within a container filled with a fluid, the system comprising:
one or more sensors operable to generate a signal indicative of a volume of the fluid in the container; and
one or more fluid composition sensors operable to quantify an attribute associated with a composition of the fluid from outside of the container.

108. The system of claim 107 wherein the one or more sensors are one or more fluid sensors operable to detect a fluid level of the fluid in the container relative to a feature of the container from the outside of the container.

109. The system of claim 107 wherein the one or more sensors are optical sensors.

110. The system of claim 107 wherein the one or more fluid composition sensors are optical sensors.

111. The system of claim 107 wherein the system is selectively configurable to utilize different types and sizes of containers.

112. The system of claim 107, further comprising:
a detector capable of detecting a unique container identifier associated with the container.

113. The system of claim 108 wherein the system is configured to calculate fluid volume based on input from the one or more fluid level sensors and physical attributes of the container.

114. The system of claim 107, further comprising:
a mechanism to move the one or more sensors and the one or more fluid composition sensors relative to a plurality of containers, or vice versa, in order to measure fluid attributes from multiple containers.

115. The system of claim 107, wherein the system is configured to compare a composition attribute from one container with measurements from other containers to verify composition homogeneity between a plurality of containers.

116. The system of claim 107 wherein the one or more sensors comprise a sensor configured to sense a combined weight of the container and the fluid from which to generate a signal indicative of the volume of the fluid received in the container.

117-130. (canceled)

131. The method of claim 1 wherein the fluid in the input container is mixed to ensure substantial homogenization prior to and during transfer.

132. The system of claim 21, further comprising:
a mixing device used to homogenize the fluid in the input container prior to and during transfer.

133. The system of claim 21, further comprising:
an output sensor for monitoring at least one output container fill parameter.

134. The method of claim 73, further comprising:
detecting a flow boundary of the fluid to assist in determining fluid location inside the manifold.

135. The method of claim 73, further comprising:
mixing the fluid in the input container to ensure substantial homogenization prior to and during transfer.

136. The method of claim 135 wherein the mixing is performed by pumping the fluid through a recirculating loop.

137. The method of claim 73, further comprising:
monitoring the fluid with a sensor to confirm that the fluid has reached a substantially homogenized state for transfer to the output containers.

138. The method of claim 135 wherein the mixing is performed by agitating the input container using mechanical paddles.

139. The method of claim 73, further comprising:
selectively switching between a first fluid input branch and a second fluid input branch.

140. The method of claim 139 wherein a second input fluid from the second fluid branch is mixed with the first input fluid.

141. The method of claim 140 wherein the second input fluid is a cryoprotectant.
